(19) United States
(12) Patent Application Publication
(10) Pub. No.: US 2026/0069495 A1
(43) Pub. Date: Mar. 12, 2026

(54) METHODS, SYSTEMS, AND APPARATUSES FOR TREATING A BIOME IN A LIVING BODY TO PROVIDE BENEFICIAL CHANGE IN HEALTH DISORDERS

(71) Applicant: Softwave Tissue Regeneration Technologies, LLC, Alpharetta, GA (US)

(72) Inventor: John F. Warlick, Talking Rock, GA (US)

(73) Assignee: Softwave Tissue Regeneration Technologies, LLC, Alpharetta, GA (US)

(21) Appl. No.: 19/018,166

(22) Filed: Jan. 13, 2025

Related U.S. Application Data
(63) Continuation of application No. 18/826,267, filed on Sep. 6, 2024.

(51) Int. Cl. A61H 23/00

(52) U.S. Cl. CPC A61H 23/008; A61H 2201/0153; A61H 2201/5058

(57) ABSTRACT

A method for modifying biome biological profile of a patient to mitigate a health disorder comprises a plurality of steps. The method includes a step for determining a current biome biological profile of a biome region of a body of the patient that predisposes the patient to a health disorder and/or promotes an existing health disorder of the patient. The method includes a step for subjecting the biome region of the patient to delivery of propagating wave energy for causing the biome region to exhibit a modified biome biological profile. The method includes a step for re-seeding the biome region with at least one biome seeding material after the biome region exhibits the modified biome biological profile for causing the biome region to exhibit a target biome biological profile.

### RELATED APPLICATIONS

The present invention is a continuation of co-pending U.S. application Ser. No. 18/826,267 filed on Sep. 6, 2024, entitled “Methods, Systems, And Apparatuses For Treating A Biome In A Living Body To Provide Beneficial Change In Health Disorders”.

### FIELD OF THE DISCLOSURE

The disclosures made herein relate generally to microbiomes (i.e., biomes) in living bodies and, more particularly, to methods, systems, and apparatuses for treating a biome in a living body to provide beneficial change in health disorders using propagating wave energy such as acoustic shock wave energy to alter a biological profile of the biome.

### BACKGROUND

The body of a living animal is inhabited by millions, if not trillions, of microbes across various locations, often referred to as biomes or microbiomes. Biomes are well known to play a key role in many adverse health conditions and diseases—i.e., generally referred to herein as health disorders. Growing evidence implicates the gut biome as a factor in the pathogenesis of a number of health disorder processes.

There are multiple causes for the imbalance of bacteria types in a biome, including the digestive tract biome, including diet, lack of exercise, chemicals, radiation exposure, electronic waves including extended exposure to cell phones and other electronics, and other biologic stressors. Extended physical, electronic, or even psychological stressors affect the inflammation of a biome which affects the types and quantities of localized and systemic bacteria types. Changes to inflammation affect the quantities and types of bacteria in any biome. These bacterial balances lead to increases or decreases in any biome.

Loss of homeostasis in the gut is thought to contribute to an imbalance associated with disease states such as immune and neurological disorders, and cause gastro-intestinal (GI) problems, which can exacerbate other health disorders and associated symptoms. For example, Autism Spectrum Disorder (ASD) is a neurodevelopmental condition affecting around 1% of the global population, characterized by challenges in social interaction, communication, behavior, and information processing. ASD is a complex neurobiological disorder whose chief manifestations are qualitative impairment in social interaction and communication and restricted repetitive and stereotyped patterns of behavior, interests, and activities. As is well known in the art, a potentially important environmental factor contributing to ASD is abnormal intestinal flora (i.e., gut biome) that often interacts with other factors such as intestinal permeability and transport of toxic substances. In this same regard, it is also known in the art that there is a correlation between gut (i.e., digestive tract) health and inflammation and, more specifically, the balance between “Good” and “Bad” bacteria in the digestive tract and the Autism.

Therefore, methods, systems, and apparatuses for treating a biome in a living body to provide beneficial change in health disorders are advantageous, desirable and useful.

### SUMMARY OF THE DISCLOSURE

Embodiments of the disclosures made herein are directed to methods, systems, and apparatuses for treating a biome in a living body to effect beneficial change in health disorders. More specifically, embodiments of the disclosures made herein advantageously provide an approach to treating a biome of a living body for the purpose of altering the biome to prevent, reduce, modulate or eliminate health disorders by correcting imbalances of the biological profile (e.g., bacteria types) of the biome. For example, it is known in the art that such imbalances in the biological profile of a digestive tract (gut) biome have correlation to autoimmune disorders (including diseases) such as fibromyalgia, chronic pain and fatigue syndromes, ASDs, and localized and systemic inflammation. To this end, embodiments of the disclosures made herein advantageously enable a biome region of a living body (e.g., the gut biome in preferred embodiments) to be altered for enabling homeostasis in a biome region (e.g., the digestive tract) to be regenerated or created and maintained.

In one or more embodiments of the disclosures made herein, a biome treatment system comprises a propagating wave energy module and an energy delivery management module operably coupled to the propagating energy wave module. The propagating wave energy module is operable to provide propagating wave energy treatment to a biome region of a body of a patient. The propagating energy wave module being enabled to provide the propagating wave energy treatment includes being operable to deliver propagating wave energy to the biome region for causing the biome region to transition from exhibiting a baseline biome biological profile to a modified biome biological profile. The energy delivery management module is operable to create a mapping of delivery of propagating wave energy relative to locations from where the propagating wave energy has been delivered to the biome region and to identify at least one location of the biome region that requires delivery of the propagating wave energy as a function of the mapping.

In one or more embodiments of the disclosures made herein, an information processing apparatus enabling modification of a biome biological profile of a patient to provide beneficial change in a health condition. The information processing apparatus is operable for receiving information characterizing delivery of propagating wave energy to a biome region of a body of the patient and generating energy delivery information at least partially dependent upon the information characterizing delivery of propagating wave energy to the biome region. The energy delivery information characterizes target placement of propagating wave energy to the biome region for causing the biome region to transition from exhibiting a baseline biome biological profile to exhibiting a modified biome biological profile that supports re-seeding of the biome region with at least one biome seeding material to achieve a target biome biological profile.

In one or more embodiments of the disclosures made herein, a method for modifying a biome biological profile of a patient to mitigate a health disorder comprises the steps of: determining a current biome biological profile of a biome region of a body of the patient that predisposes the patient to a health disorder and/or promotes an existing health disorder of the patient; subjecting the biome region of the patient to delivery of propagating wave energy for causing the biome region to exhibit a modified biome biological profile; and after the biome region exhibits the modified biome biological profile, re-seeding the biome region with at least one biome seeding material for causing the biome region to exhibit a target biome biological profile.

In one or more embodiments, the baseline biome chemistry is a biome chemistry prior to propagating wave energy treatment.

In one or more embodiments, the modified biome chemistry is a biome chemistry supporting a standard of care for enabling biological re-seeding of the biome region.

In one or more embodiments, the energy delivery management module being operably coupled to the propagating energy wave module includes the energy delivery management module being one of: unitarily embodied with the propagating energy wave module; integral with the propagating energy wave module; and a discrete unit operably connected to the propagating energy wave module.

In one or more embodiments, the energy delivery management module being operable to create the mapping includes the energy delivery management module being operable to record locations of delivery of the propagating wave energy during a first portion of a session of the propagating wave energy treatment.

In one or more embodiments, the energy delivery management module being operable to identify the at least one location of the biome region that requires propagating wave energy treatment includes the energy delivery management module being operable to indicate at least one location for delivery of the propagating wave energy during a second portion of the session of the propagating wave energy treatment as a function of the recorded locations.

In one or more embodiments, the energy delivery management module being operable to create the mapping includes the energy delivery management module being operable to determine at least one of a location of the biome region that requires initial propagating wave energy treatment and a location of the biome region that requires delivery of additional propagating wave energy.

In one or more embodiments, a spatial referencing module is operably coupled to at least one of the propagating energy wave module and the energy delivery management module and the spatial referencing module generates location information characterizing locations from where propagating wave energy has been delivered to the biome region.

In one or more embodiments, the spatial referencing module includes a first position-defining device attached to a propagating wave energy applicator of the propagating energy wave module and a second position-defining device positionable at a fixed remote location from the propagating wave energy applicator for enabling the first position-defining device and the second position-defining device to jointly facilitate determining at least one of movement of the propagating wave energy applicator and position of the propagating wave energy applicator.

In one or more embodiments, the spatial referencing module includes a spatial field generator, a first sensor attached to a propagating wave energy applicator of the propagating energy wave module and an algorithm operable to integrate and localize movement of the applicator at least one of 2-dimensional space and 3-dimensional space as a function of spatial information generated jointly by the spatial field generator and the first sensor.

In one or more embodiments, the biome treatment system comprises an ultrasound module comprising an ultrasound emitter.

In one or more embodiments, the spatial referencing module includes a second sensor attached to the ultrasound emitter and the algorithm is operable to localize a target location within the biome region as a function of spatial information generated jointly by the spatial field generator and the second sensor.

In one or more embodiments, the energy delivery management module being operable to create the mapping includes the energy delivery management module being operable to associate locations from where propagating wave energy has been delivered to the biome region to a location on an image depicting at least a portion of the biome region.

In one or more embodiments, the energy delivery management module being operable to determine at least one location of the biome region that requires propagating wave energy treatment includes the energy delivery management module being operable to assess propagating wave energy delivered over a prescribed area of the biome region and identifying at least one portion of the prescribed area where the propagating wave energy delivered therein is below a prescribed threshold.

In one or more embodiments, the energy delivery management module is operable for causing display of an image depicting at least a portion of the biome region.

In one or more embodiments, the energy delivery management module being operable to map locations from where propagating wave energy has been delivered to the biome region and to determine the location of the biome region that requires propagating wave energy treatment includes the energy delivery management module being operable to determine a location of the biome region where an amount of propagating wave energy has been delivered in an amount below a prescribed threshold.

In one or more embodiments, the location of the biome region where an amount of propagating wave energy has been delivered in an amount below a prescribed threshold is indicated on an image depicting at least a portion of a biome region.

In one or more embodiments, generating energy delivery information includes accessing recorded locations of delivery of propagating wave energy to the biome region during a first portion of a session of propagating wave energy treatment and determining locations for delivery of propagating wave energy during a second portion of the session of propagating wave energy treatment utilizing recorded locations to identify at least one location for delivery of propagating wave energy during the second portion of the session of propagating wave energy treatment.

In one or more embodiments, generating energy delivery information includes determining at least one of a location of the biome region that requires initial propagating wave energy treatment and a location of the biome region that requires delivery of additional propagating wave energy.

In one or more embodiments, generating energy delivery information includes recording locations from where propagating wave energy has been sufficiently delivered to the biome region for enabling the biome region to transition from exhibiting the current biome chemistry to exhibiting the modified biome chemistry and determining at least one location of the biome region that requires propagating wave energy treatment for enabling the biome region to transition from exhibiting the current biome chemistry to exhibiting the modified biome chemistry.

In one or more embodiments, an information processing apparatus is operable for receiving information defining locations from which propagating wave energy is delivered to the biome region and generating energy delivery information is performed as a function of such locations.

In one or more embodiments, an information processing apparatus is operable for assessing propagating wave energy delivered to locations of the biome region, identifying one of such locations where the propagating wave energy delivered thereto is below a prescribed threshold, and causing such location to be displayed on an image depicting at least a portion of the biome region.

In one or more embodiments, an information processing apparatus is operable for receiving location information from a spatial referencing module defining a plurality of target locations within the biome region, spatially mapping the target locations relative to each other to create a visual depiction of the target locations, and causing the visual depiction to be displayed in conjunction with an image depicting at least a portion of the biome region.

These and other objects, embodiments, advantages and/or distinctions of the present invention will become readily apparent upon further review of the following specification, associated drawings and appended claims.

### DEFINITIONS AND ASSOCIATED DISCLOSED FUNCTIONALITIES

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different ways, for example: A focused wave will become divergent once it has passed through the focal point. Spherical waves are also included in this definition of divergent waves and have wave fronts with divergent characteristics.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “pressure pulse” according to one or more embodiments of the disclosures made herein is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nanoseconds (ns) up to some milliseconds (ms). Very fast pressure pulses are called shock waves. Shock waves used in medical applications do have amplitudes above 0.1 MPa and rise times of the amplitude can be below 1000 ns, preferably at or below 100 ns.

“Senescence” refers to loss of a cell's power of division and growth, also the condition or process of deterioration with age. It can refer to either cellular senescence or to senescence of the whole organism. Senescence is a process in which cells reach permanent growth arrest without the death of cells as the whole cell division process stops. A senescent cell is alive but cannot divide, but also has an active metabolism and secretes signaling molecules to communicate with other cells which can be beneficial, such as during wound healing, or detrimental, in the case of chronic inflammation. Senescence is an example of a cellular response that may be mitigated (e.g., via promoting generation of new cells) in response to stimulation of cells in accordance with embodiments of the disclosures made herein.

“Shock Wave”: As used herein is defined by Camilo Perez, Hong Chen, and Thomas J. Matula; Center for Industrial and Medical Ultrasound, Applied Physics Laboratory, University of Washington, 1013 NE 40th Street, Seattle, Washington 98105; Maria Karzova and Vera A. Khokhlovab; Department of Acoustics, Faculty of Physics, Moscow State University, Moscow 119991, Russia; (Received 9 Oct. 2012; revised 16 Apr. 2013; accepted 1 May 2013) in their publication, “Acoustic field characterization of the Duolith: Measurements and modeling of a clinical shock wave therapy device”; incorporated by reference herein in its entirety.

“Telomeres” play a central role in cell fate and aging by adjusting the cellular response to stress and growth stimulation on the basis of previous cell divisions and DNA damage. At least a few hundred nucleotides of telomere repeats must “cap” each chromosome end to avoid activation of DNA repair pathways. Repair of critically short or “uncapped” telomeres by telomerase or recombination is limited in most somatic cells and apoptosis or cellular senescence is triggered when too many “uncapped” telomeres accumulate. Telomerase and recombinations thereof are examples of proteins that may be released in response to stimulation of cells in accordance with embodiments of the disclosures made herein that promote regulation and lengthening of telomeres such as, for example, via activation of DNA repair pathways.

Waves/wave fronts described as being “focused” or “having focusing characteristics” means in the context of the present invention that the respective waves or wave fronts are traveling and increase their amplitude in direction of the focal point. Per definition, the energy of the wave will be at a maximum in the focal point or, if there is a focal shift in this point, the energy is at a maximum near the geometrical focal point. Both the maximum energy and the maximal pressure amplitude may be used to define the focal point.

“Standard of Care”: Treatment that is accepted by medical experts as a proper treatment for a certain type of medical disorder (e.g., a disease) and that is widely used by health care professionals.

### BRIEF DESCRIPTION OF THE DRAWINGS

FIG. 1A is a flow diagram view of a method for modifying a biome biological profile of a patient to mitigate a health disorder in accordance with one or more embodiments of the disclosures made herein.

FIG. 1B is a block diagram of a step for subjecting a biome region to propagating wave energy in accordance with one or more embodiments of the disclosures made herein.

FIG. 2 is a block diagram of a system for modifying a biome biological profile of a patient to mitigate a health disorder in accordance with one or more embodiments of the disclosures made herein.

FIG. 3 is a diagrammatic view of a mapping of propagating wave energy delivery relative to delivery location in accordance one or more embodiments of the disclosures made herein.

FIG. 4 is a block diagram of a network infrastructure including a computing system adapted for implementing energy delivery management functionalities in accordance with one of more embodiments of the disclosures made herein.

FIG. 5 is a diagrammatic view of a pressure pulse/shock wave (PP/SW) generator showing focusing characteristics of transmitted acoustic pressure pulses.

FIG. 6 is a diagrammatic view of a pressure pulse/shock wave generator with plane wave characteristics.

FIG. 7 is a diagrammatic view of a pressure pulse shock wave generator (i.e., a shock wave head of a propagating energy wave source) with divergent wave characteristics.

FIG. 8 is a diagrammatic view of an exemplary acoustic shock wave apparatus in accordance with one or more embodiments of the disclosures made herein.

### DETAILED DESCRIPTION

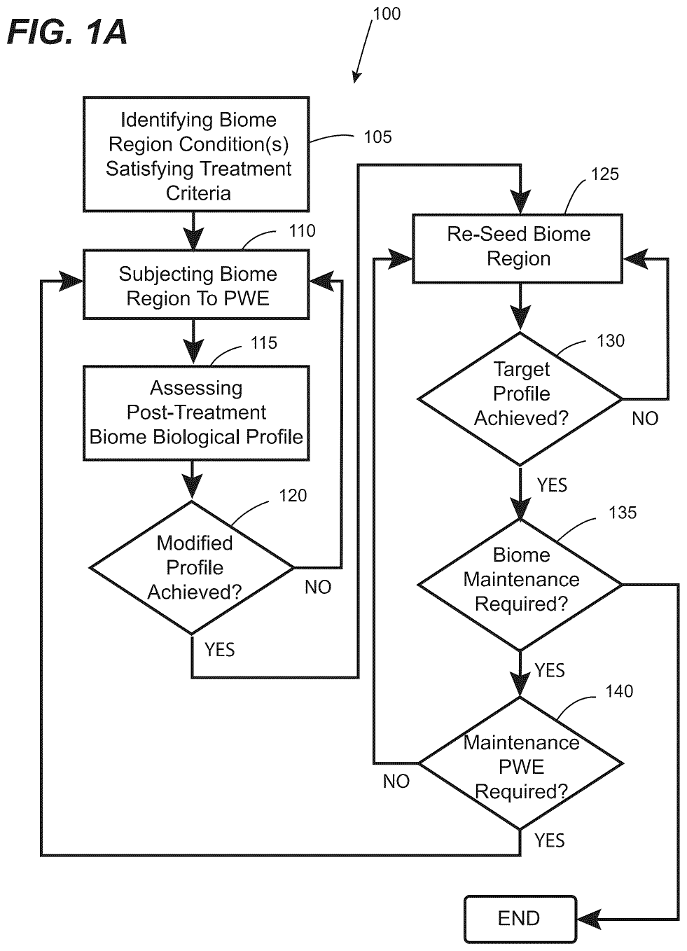

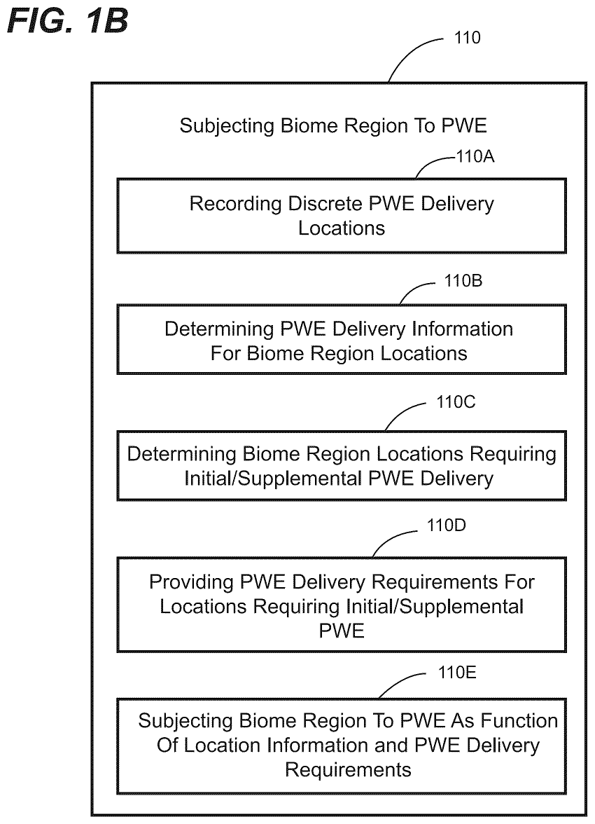

Referring to FIG. 1A, a method in accordance with one or more embodiments of the disclosures made herein is shown—i.e., method 100. The method 100 may include a step 105 for identifying biome region conditions of a body of a patient that satisfy biome re-seeding for the purpose of altering the biome to prevent, reduce, modulate or eliminate health disorders by correcting imbalances of the biological profile (e.g., bacteria types) in the biome. Identifying such biome region conditions may involve determining a baseline biological profile of the biome region that predisposes the patient (or patient off-spring) to a health disorder and/or promotes an existing health disorder of the patient. The baseline biome biological profile may be the biome biological profile prior to treatment or after an initial treatment where there are a series of treatments (or portions of a single treatment). A biome may be associated with regions of the body (i.e., biome regions) including, but not limited to, all or a portion of an organ, all or a portion of an organelle, all or a portion of a vesicle, all or a portion of an eyeball (i.e. a globe), all or a portion of a digestive tract (i.e., a functional tract), tissue which may be inflamed, and the like.

The method 100 may include a step 110 for subjecting all or a portion of the biome region to delivery of propagating wave energy (e.g., delivery of acoustic shock wave energy) after determining that the current biome biological profile satisfied requirements for altering the biome to prevent, reduce, modulate or eliminate health disorders by correcting imbalances of the biological profile (e.g., bacteria types) in the biome via resetting the biome profile via delivery of (i.e., treatment with) propagating wave energy. More particularly, delivering propagating wave energy to the biome region may include subjecting the biome region of the patient to propagating wave energy for causing the biome region to exhibit a modified biome biological profile. The modified biome biological profile is a different biome biological profile different than the baseline biome biological profile. For example, the biome biological profile may be altered to exhibit a modified consortia of bacteria and other biological constituent components (e.g., a modified proportion and/or presence of given bacteria and other biological constituent components).

Propagating energy wave treatment, such as acoustic shock wave therapy, may be applied using any suitable approach that is known in the art. Specific details of acoustic shock waves and treatment therewith as related to treating a patient having an infection from bacteria, molds, fungi, and/or virus by destroying such bacteria, molds, fungi, and/or virus using acoustic shock waves are disclosed in United States Patent Application Publication No. 20200368377, which is incorporated herein in its entirety by reference.

A propagating energy wave source delivering propagating wave energy in accordance with embodiments of the disclosures made herein may be any type of source of propagating energy waves that offers propagating energy waves in a form suitable for facilitating biome treatment in accordance with embodiments of the disclosures made herein. Although acoustic shock waves are a suitable type of propagating energy wave (i.e., pressure pulses) useful for biome treatment in accordance with embodiments of the disclosures made herein, a skilled person will understand that other types of propagating energy waves (e.g., radial pressure waves, acoustic pneumatic waves, ultrasonic waves, and the like) may be useful for biome treatment in accordance with embodiments of the disclosures made herein.

As shown in FIG. 1B, subjecting the biome region (e.g., all or a portion thereof) to delivery of propagating wave energy may be performed on a location-specific basis. Subjecting the biome region to delivery of propagating wave energy may include causing locations of delivery of propagating wave energy during a first portion of such subjecting to be recorded (See Block 110A). Subjecting the biome region to delivery of propagating wave energy may include determining propagating wave energy delivery information for recorded biome region locations (See Block 110B). Examples of such propagating wave energy delivery information may include, but not be limited to, amount of propagating wave energy delivered, area of biome region over which propagating wave energy is delivered for a given location of energy application, duration of time propagating wave energy is delivered for a given location of energy application, and the like. In regard to gut biome treatment, the use of anti-gas meds/supplements and maximizing patient hydration may optimize efficacy of propagating wave energy delivery.

Subjecting the biome region to delivery of propagating wave energy may include determining locations of the biome region that requires initial delivery of the propagating wave energy and/or determining locations of the biome region that require additional delivery of the propagating wave energy (See Block 110C). Subjecting the biome region to delivery of propagating wave energy may include performing delivery of the propagating wave energy during a first portion of such subjecting in a random, manually-methodical manner, or algorithm-computed methodical manner and then determining propagating energy wave delivery requirements during a second portion of such subjecting based upon algorithm-computed methodical manner derived as a function of the location information characterizing locations of delivery of the propagating wave energy to the biome region during a first portion of such subjecting—e.g., delivery location information generated by an energy delivery management algorithm (See Block 110D). The energy delivery management algorithm may be operable to integrate and localize movement of an applicator of a propagating wave energy delivery module in 2-dimensional space and/or 3-dimensional space as a function of spatial information generated jointly by a fixed location referencing device and a translating location referencing device. Such determining of the propagating energy wave delivery requirements for during the second portion of such subjecting may be at least partially based upon one or more conditional parameters of the modified biome biological profile resulting from delivery of the propagating wave energy during the first portion of such subjecting (e.g., a given concentration of bacteria present and/or a particular type of bacteria present).

Delivery of propagating wave energy during the second portion of such subjecting may include performing delivery of the propagating wave energy during the second portion of such subjecting as a function of the delivery location information. One example of the delivery location information is how much propagating wave energy to deliver and where to deliver such energy from and/or to. Such delivery may be performed in response to one or more conditional parameters indicating that the modified biome biological profile resulting from delivery of the propagating wave energy during the first portion of such subjecting is not at least one of within a target range and at a target level (See Block 110E).

The method 100 may include a step 115 for assessing the biome biological profile after delivery of the propagating wave energy to the biome region. As discussed above, the objective of such delivery of propagating wave energy to the biome region is to cause the biome biological profile of the biome region to transition from the baseline biome biological profile to the modified biome biological profile. To this end, it is expected that there is a specified biome biological profile (e.g., constituent component make-up) that indicates when a sufficient amount and/or spatial breadth of propagating wave energy has been applied to the biome region. For example, the biome biological profile may be altered to exhibit a modified proportion and/or presence of given bacteria and other biological constituent components, a modified consortia of bacteria and other biological constituent components, or other form of alteration of biological constituent components relative to that of the baseline biome biological profile. Inflammation may also be a biome biological profile assessment criteria.

The method 100 may include a step 120 for determining if a desired modified biome biologic profile has been achieved following delivery of the propagating wave energy to the biome region. If the desired modified biome biologic profile has not been achieved, the method 100 returns to the step 110 for delivery of additional delivery of the propagating wave energy to all or a portion of the biome region. If the desired modified biome biologic profile has been achieved, the method 100 may include a step 125 for re-seeding the biome region with at least one biome seeding material for causing the biome region to exhibit a target biome biological profile.

Re-seeding the biome region can be performed in accordance with a known or yet-to-be-discovered standard of care. In the case of a biome region in or comprising a digestive tract, a skilled person will understand that such standard of care may utilize at least one biome seeding material which may comprise or consist of, for example, proper bacterial types, fecal-derived implants, vaginal-derived implants, donor-derived-implants, probiotics, biological supplements, and/or combinations thereof. In the case where the biome region is a gut biome, it is well known that beneficial gut bacteria play a role in lowering risk for chronic diseases such as, for example, asthma, obesity, allergies, dermatitis, inflammatory bowel disease, and neurodevelopmental disorders. To this end, the biome seeding material(s) for a given biome region (e.g., a gut biome) will be selected to enhance and nurture that particular biome region.

The method 100 may include a step 130 for determining if a target biome biologic profile has been achieved following re-seeding of the biome region. If the target biome biologic profile has not been achieved, the method 100 may return to the step 125 for delivery of additional biomed seeding material(s). The additional biome seeding material (s)may be the same as that used previously or may be different that the biome seeding material(s) previously used. If the target biome biologic profile has been achieved, the objective of altering the biome to prevent, reduce, modulate or eliminate health disorders by correcting imbalances of the biological profile (e.g., bacteria types) in the biome is achieved.

If the target biome biologic profile is determined to have been achieved at the step 130, the method 100 may include a step 135 for determining if biome maintenance is required. In some embodiments, on-going biome maintenance may be required or recommended. For example, routine or periodic testing may identify a biome condition where such biome maintenance is required or recommended (e.g., imbalance of the biological profile in the biome, further refining/optimizing balance of biological profile, etc.). If biome maintenance is determined to not be required, the method 100 may end. Otherwise, the method may include a step 140 for determining if such biome maintenance requires delivery of propagating wave energy to all or a portion of the biome region. For example, the biome condition identified in the aforementioned routine or periodic testing may require an undesirable bacteriological condition to be resolved via delivery of propagating wave energy prior to maintenance re-seeding the biome region.

If it is determined that such biome maintenance requires delivery of propagating wave energy, the method 100 may continue at the step 110 for performing delivery of propagating wave energy to all or a portion of the biome region. The specific manner in which propagating wave energy is delivered may be the same or different than that of a prior instance of such delivery of propagating wave energy to the biome region. Otherwise, if it is determined that such biome maintenance does not require delivery of propagating wave energy, the method 100 may continue at the step 125 for re-seeding the biome region with at least one biome seeding material for causing the biome region to exhibit a target biome biological profile. The target biome biological profile for biome maintenance may be the same or different than that for a prior instance of re-seeding.

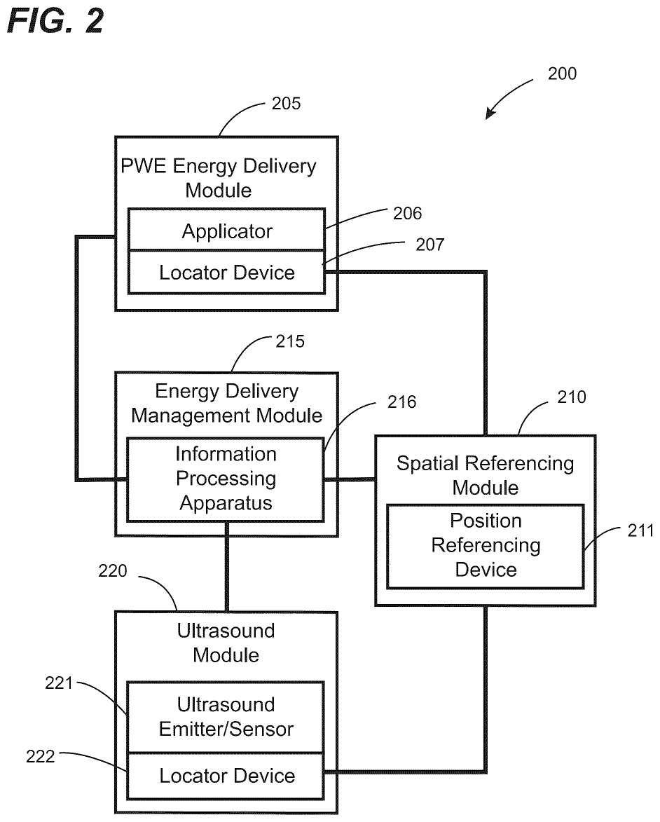

Referring to FIG. 2, a system in accordance with one or more embodiments of the disclosures made herein is shown—i.e., the system 200. The system 200 is operable for enabling modification of a biome biological profile of a biome region of a patient in accordance with one or more embodiments of the disclosures made herein. For example, the system 200 may be configured in a manner supporting execution of the method 100 discussed above in reference to FIGS. 1A and 1B.

The system 200 includes a propagating wave energy module 205, a spatial referencing module 210, an energy delivery management module 215, and an ultrasound module 220. The propagating wave energy module 205 is operably coupled to the spatial referencing module 210 and the energy delivery management module 215. The energy delivery management module 215 is operably coupled to the ultrasound module 220. The spatial referencing module 210 is operably coupled to the propagating wave energy module 205, the ultrasound module 220, and the energy delivery management module 215. All or some of the modules 205, 210, 215, 220 may be standalone systems. Two or more of the modules 205, 210, 215, 220 may be integral with each other as a standalone system, apparatus, or device. Embodiments of the disclosures made herein are not limited to a particular physical structure, but rather are characterized by structure and/or functionality as disclosed herein and appreciated in view of the disclosures made herein.

The propagating wave energy module 205 includes an applicator 206 and a locator device 207. The applicator 206 is a device from which propagating energy waves are emitted for enabling treatment of a respective portion of a body. The locator device 207 is coupled to (e.g., fixedly attached to) the applicator 206 for outputting a signal that enables relative position and/or motion of the applicator 206 to be tracked and/or recorded. Specific details of acoustic shock wave delivery (i.e., propagating wave energy) systems and treatment therewith are disclosed in U.S. Pat. Nos. 7,470,240; 7,507,213; 7,601,127; 7,695,443; 8,257,282; 11,311,454; 11,389,371, which are incorporated herein in their entirety by reference.

As is well known in the art, propagating energy waves, such as acoustic shock waves, for example, may be applied to the biome region via the esophagus, trans-rectally, or non-invasively via topical application. In view of the disclosures made herein, a skilled person will appreciate that the delivery of propagating energy waves such as acoustic shock waves may be via utilization of electrohydraulic shock wave systems with non-invasive application via parabolic or broadly focused shock waves or an esophageal applicator, stent or catheter delivery system. The skilled person will also appreciate that an invasive applicators may be fluid filled, may include a single or multiple sets of electrode tips that can generate shock waves with each discharge, may utilize spherical discharges in view of more rapidly covering larger treatment areas, may utilize applicator tip sets that discharge through a membrane that can expand with increased water or saline pressure, and may utilize a delivery system that discharges propagating energy waves through a fixed membrane or window.

The spatial referencing module 210 may be operably coupled (e.g., wirelessly) to the locator device 207 that is coupled (e.g., physically) to the applicator 206 of the propagating wave energy module 205 to receive or sense a location-reference signal outputted by the locator device 207 of the propagating wave energy module 205. In this respect, the locator device 207 may be a first sensor of the spatial referencing module 210 that serves to enable the position of the applicator 206 to be defined (i.e., a first position-defining device). The spatial referencing module 210 may be operably coupled to the propagating energy wave module 205 in a plurality of ways, including, but not limited to: unitarily embodied with the propagating energy wave module 205, integral with the propagating energy wave module 205, and a discrete unit operably connected to the propagating energy wave module 205.

The spatial referencing module 210 is operable to utilize the location-reference signal outputted by the locator device 207 to generate location information characterizing position and/or movement of the applicator 206 via its coupling to the locator device 207. More specifically, the location information may characterize locations from where propagating wave energy has been delivered to the biome region. To this end, the spatial referencing module 210 may track and/or record instances of relative position of the applicator 206 and/or instances of motion of the applicator 206.

For interacting with the locator device 207 to generate the location information, the spatial referencing module 210 may include a position reference device 211 (i.e., a second position-defining device). The position reference device 211 is preferably positioned at a fixed remote location from the applicator 206 (and thus the locator device 207). Jointly, via signaling therebetween, the locator device 207 and the position reference device 211 enable determination of movement of the applicator 206 and/or position of the applicator 206. For example, the position reference device 211 may comprise a spatial field generator or other type of spatial location referencing device that enables location of the locator device 207 (and thus the applicator 206) to be determined with sufficient resolution for enabling the location information to be generated (preferably in a real-time manner) as a function of location of the applicator 206. In some embodiments, a source of emission of propagating waves from the applicator 206 may be all or part of the locator device 207 (i.e., point source of the propagating wave energy defines the instant location of the applicator 206).

The energy delivery management module 215 includes an information processing apparatus 216. The energy delivery management module 215 is operably coupled to the propagating wave energy module 205, the ultrasound module 220, and the spatial referencing module 210. Through such coupling, the information processing apparatus 216 may receive information from and/or provide information to such modules coupled to the energy delivery management module 215. Via such information communication, the information processing apparatus 216 is operable for receiving information characterizing delivery of propagating wave energy to a biome region of a body of a patient and generating energy delivery information at least partially dependent upon the information characterizing delivery of propagating wave energy to the biome region. The energy delivery management module 215 may be operably coupled to the propagating energy wave module 205 in a plurality of ways, including, but not limited to: unitarily embodied with the propagating energy wave module 205, integral with the propagating energy wave module 205, and a discrete unit operably connected to the propagating energy wave module 205.

Generating energy delivery information may include accessing recorded energy delivery information corresponding to a first portion of a session of propagating wave energy treatment and determining energy delivery information for during a second portion of the session of propagating wave energy treatment utilizing the energy delivery information from the first portion of the session. Examples of such energy delivery information include delivery location, energy amount, and duration of delivery. The energy delivery information for the second portion of the session may characterize target placement of propagating wave energy to the biome region for causing the biome region to achieve transition from exhibiting a baseline biome biological profile to exhibiting a modified biome biological profile that supports re-seeding of the biome region with at least one biome seeding material to achieve a target biome biological profile.

The energy delivery management module 215 may be operable for creating a mapping of delivery of propagating wave energy relative to locations from where the propagating wave energy has been delivered to the biome region and/or where propagating wave energy needs to be delivered to the biome region. Such mapping may include correlation between two or more of the following parameters: one or more location (e.g., area) of the biome region subjected to initial delivery of propagating wave energy; one or more locations of the biome region not subjected to initial delivery of propagating wave energy; one or more locations of the biome region subjected to additional delivery of propagating wave energy; one or more locations of the biome region requiring additional delivery of propagating wave energy; an amount of propagating wave energy delivered/required to be delivered; a duration of time propagating wave energy has been/is required to be delivered; an amount of propagating wave energy required to cause transformation from the baseline biome biological profile to the modified biome biological profile, and the like. In a preferred embodiment, the mapping correlates location of delivery to at least one of: one or more locations of the biome region requiring initial delivery of propagating wave energy; one or more locations of the biome region requiring additional delivery of propagating wave energy; an amount of propagating wave energy required to be delivered; and a duration of time propagating wave energy is required to be delivered.

In conjunction with mapping locations from where propagating wave energy has been delivered to the biome region and determining one or more locations of the biome region that require propagating wave energy treatment, the energy delivery management module 215 may be operable for determining a location of the biome region where an amount of propagating wave energy has been delivered in an amount below a prescribed threshold. For example, to achieve a desired modified biome biological profile, a prescribed minimum amount of propagating wave energy must be delivered to all or a portion of the biome region over all of or during each of one or more treatment sessions. In creating the mapping, the energy delivery management module 215 may associate locations from where propagating wave energy has been delivered to the biome region to a location on a visual depiction (e.g., image, photograph, map, diagram, rendering, or the like) depicting at least a portion of the biome region. Accordingly, the energy delivery management module 215 may be operable for assessing propagating wave energy delivered to locations of the biome region, identifying one or more of such locations where the propagating wave energy delivered thereto is below a prescribed threshold, and causing one or more of such locations to be displayed on a visual depiction showing at least a portion of the biome region. Thus, in one or more embodiments, the energy delivery management module 215 may be operable for receiving location information from a spatial referencing module defining a plurality of target locations within the biome region, spatially mapping the target locations relative to each other to create a visual depiction of the target locations, and causing the visual depiction to be displayed in conjunction with an image depicting at least a portion of the biome region.

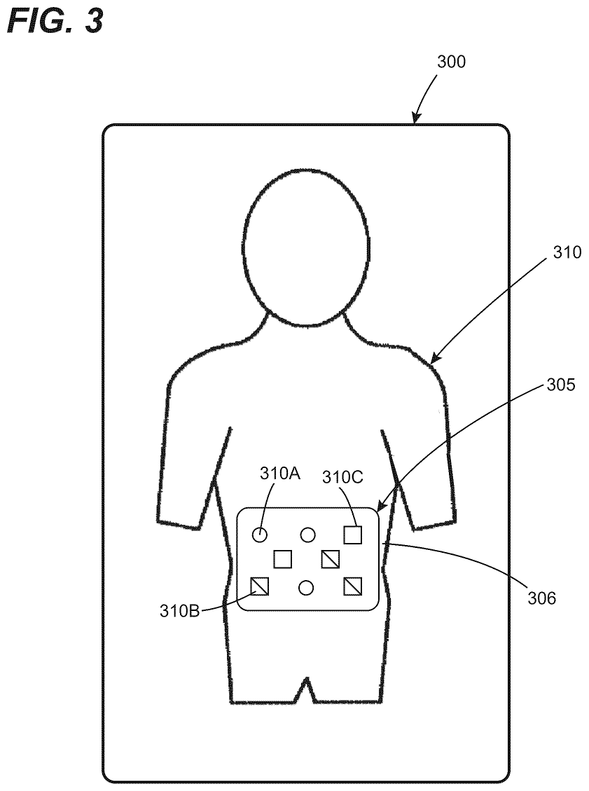

An example of a visual depiction 300 including an energy delivery mapping in accordance with one or more embodiments of the disclosures made herein is shown in FIG. 3. The visual depiction 300 includes a mapping 305 of categories of propagating wave energy delivery locations 310A, 310B, 310C relative to an abdominal region 306 (e.g., gut biome region treatment) of a patient 310. The propagating wave energy delivery location 310A is a delivery location category corresponding to not yet having had an initial delivery of propagating wave energy. The propagating wave energy delivery location 310B is a delivery location category corresponding to having had delivery of propagating wave energy (initial or otherwise) and not requiring additional delivery of propagating wave energy. The propagating wave energy delivery location 310C is a delivery location category corresponding to having had delivery of propagating wave energy (initial or otherwise) and requiring additional delivery of propagating wave energy. Other information that may be depicted on a location specific basis includes, but is not limited to, an amount (quantitatively or qualitatively depicted) of propagating wave energy delivered/required to be delivered; a duration of time propagating wave energy has been/is required to be delivered; and an amount of propagating wave energy required to cause transformation from the baseline biome biological profile to the modified biome biological profile.

The ultrasound module 220 may be a conventional ultrasound system or configured similarly to a conventional ultrasound system. A primary utility of a conventional ultrasound system is imaging of internal bodily structures. As is well known, a conventional ultrasound system includes an emitter/sensor 221 that emits ultrasonic energy waves and senses a reflected portion of such emitted ultrasonic energy waves. The reflected portion of such emitted ultrasonic energy waves are processed to derive an image of the object (e.g., internal bodily structure) from which the reflected portion of such emitted ultrasonic energy waves are reflected. The image may be visually displayed, recorded as data, and/or outputted a signal defining such data. The

In accordance with one or more embodiments of the disclosures made herein, a locator device 222 may be coupled to (e.g., fixedly attached to) the emitter/sensor 221 for outputting a signal that enables relative position and/or motion of the emitter/sensor 221 to be tracked and/or recorded. The spatial referencing module 210 is operable to utilize a location-reference signal outputted by the locator device 222 to generate location information characterizing position and/or movement of the emitter/sensor 221 via its coupling to the locator device 222. Operability of the spatial referencing module 210 is discussed above. The location information for the emitter/sensor 221 may be used to localize (e.g., characterize location of) and/or visualize a target bodily structure associated with a biome region in real time. For example, the emitter/sensor 221 in combination with the locator device 222 may be used to generate an image and associated relative reference locations thereof of the target bodily structure. The energy delivery management module 215 may receive a signal from the ultrasound module 220 processible to facilitate mapping of energy delivery information as a function of, for example, such image and associated relative reference locations thereof of the target bodily structure generated through use of the emitter/sensor 221 and locator device 222 coupled thereto.

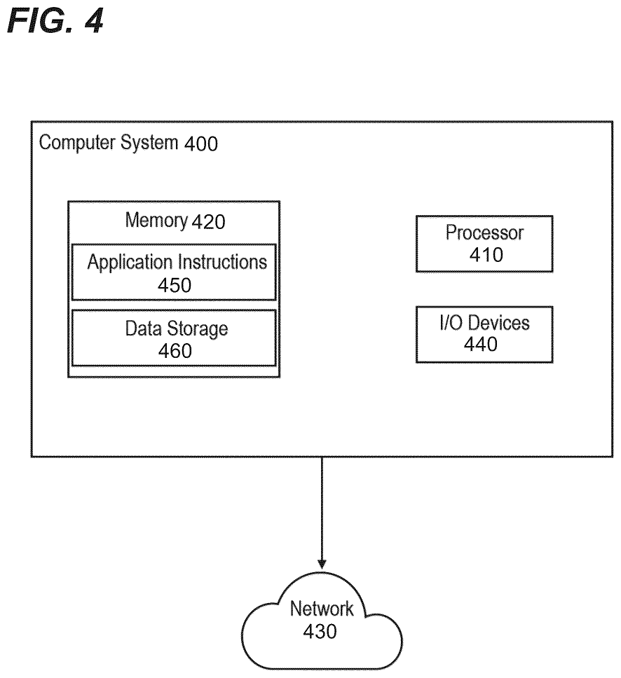

Referring to FIG. 4, to perform its required functionalities, the information processing apparatus 216 operates to process required information (i.e., output information) as a function of input information. Examples of such functionality are discussed above in reference to the method of FIG. 2 and location delivery mapping of FIG. 3. In performing such functionalities, the information processing apparatus 216 may be implemented as a computing system 400 (e.g., embodied as a special-purpose computer system) for carrying out processor-implemented methodologies to automate various algorithmic operations (e.g., step-wise instruction, computer program code, or the like) embodying such methodologies. The computing apparatus 400 may be a standalone apparatus or may be fully or partially integrated with the propagating wave energy module 205. The computing system 400 is an example of an information processing apparatus.

The computer system 400 may include one or more processors (processor(s) 410) coupled to a memory 420 via an input/output (I/O) interface. Computer system 400 may further include a network interface to communicate with a network 430. The computer system 400 includes one or more input/output (I/O) devices 440, such as video device(s) (e.g., a camera), audio device(s), and visual display(s). In some embodiments, similar I/O devices 440 may be separate from computer system 400 and may interact with one or more nodes of the computer system 400 through a wired or wireless connection, such as over a network interface.

Processor(s) 410 suitable for the execution of a computer program include both general and special purpose microprocessors and any one or more processors of any digital computing device. Processor(s) 410 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 400 and other devices attached to a network 430, such as other computer systems, or between nodes of the computer system 400, or other system modules in accordance with embodiments of the disclosures made herein. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

Memory 420 may include application instructions 450, configured to implement certain aspects of embodiments described herein (e.g., functionality for modifying biome biological profile of a patient to mitigate a health disorder), and data storage (e.g., comprising or consisting of a database) 460, comprising various data accessible by the application instructions 450. In one embodiment, the application instructions 450 may include software elements (set of processor-executable instructions embodied as computer program code) corresponding to one or more of the various embodiments described herein. For example, application instructions 450 may be implemented in various embodiments using any desired programming language, scripting language, or combination of programming languages and/or scripting languages (e.g., C, C++, C#, JAVA®, JAVASCRIPT®, PERL®, etc.).

Memory 420 may information associated with implementing functionality for modifying biome biological profile of a patient to mitigate a health disorder in accordance with one or more embodiments of the disclosures made herein. For example, memory 420 may be non-transient computer-readable media having information stored thereon embodying functionality provided by the energy delivery management module 215 and spatial referencing module 210 discussed above in reference to FIG. 2.

The operations and actions of the computer system 400 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to processor(s) 410 such that processor(s) 410 can read information from, and write information to, the storage medium. In the alternative, the storage medium may be integrated into processor(s) 410. Further, in some embodiments, processor(s) 410 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium and, more preferably, a non-transitory computer-readable medium/media. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

The term “computer-readable medium” as used herein refers to any medium (but, preferably non-transitory) that participates in providing instructions to processor(s) 410 for execution. Such a medium may take many forms, including but not limited to, non-volatile media, volatile media, and transmission media. Non-volatile media includes, for example, optical or magnetic disks. Volatile media includes dynamic memory, such as memory 420. Transmission media includes coaxial cables, copper wire, and fiber optics, including the wires that comprise a bus. Transmission media can also take the form of acoustic or light waves, such as those generated during radio-wave and infra-red data communications. Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read. Various forms of computer readable media may be involved in carrying one or more sequences of one or more instructions to processor(s) 410 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on a bus. A bus in this regard may carry data to memory (e.g., memory 420), from which a processor (e.g., the one or more processors 410) retrieves and executes the instructions. The instructions received by memory may optionally be stored on a storage device either before or after execution by a processor. To this end, the one or more processors 410, the memory 420 and I/O devices 440 are preferably interconnected with each other via a bus or similar communication structure.

In some embodiments, the computing system 400 is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In preferred embodiments, treatment of tissue with propagating wave energy in accordance with one or more embodiments of the disclosures made herein may activate and/or normalize cellular function. To this end, such treatment may include activating an acoustic shock wave source (e.g., generator) to emit acoustic shock waves and subjecting target tissue of a patient to one or more treatments of exposure to acoustic shock waves. The acoustic shock waves provide pressure pulses each comprising a plurality of cycles of a positive pressure part and a negative pressure part. Subjecting the target tissue of the patient to the plurality of treatments of exposure to the acoustic shock waves is performed for causing stimulation of cells of the target tissue to initiate genetic expression of cells of the target tissue. Such stimulation of cells of the target tissue to initiate genetic expression may cause one or more of release of exosomes from cells of targeted (i.e., treated) tissue, activation of at least one cellular receptor, shedding of micro-vesicles from the cells of targeted tissue, and release of at least one of a protein, cytokines, and mRNA from the cells of targeted tissue into the extracellular matrix of the targeted tissue.

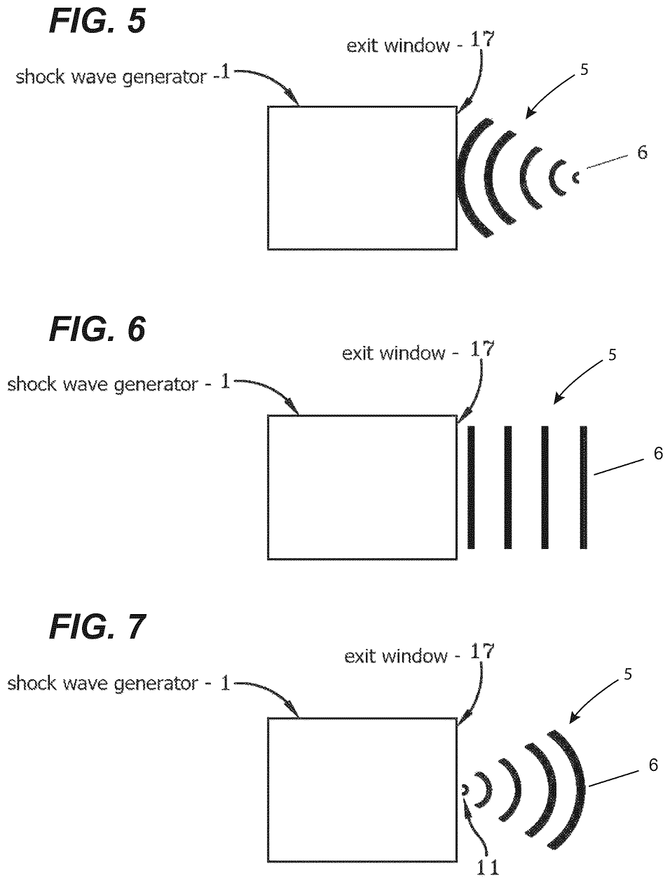

With reference to FIGS. 5-8 variety of schematic views of acoustic shock waves or pressure pulses are described. The following description of the proper amplitude and pressure pulse intensities of the shock waves are provided along with a description of how the shock waves actually function. For the purpose of describing, the shock waves were used as exemplary and are intended to include all of the wave patterns discussed in the figures as possible treatment patterns. Specific details of acoustic shock waves and treatment therewith are disclosed in U.S. Pat. Nos. 7,470,240; 7,507,213; 7,601,127; 7,695,443; 8,257,282; 11,311,454; 11,389,371, which are incorporated herein in their entirety by reference.

FIG. 5 is a simplified depiction of a pressure pulse/shock wave (PP/SW) generator, such as a shock wave head, showing focusing characteristics of transmitted acoustic pressure pulses 5. Numeral 1 indicates the position of a generalized pressure pulse generator (i.e., propagating energy wave source 1), which generates pressure pulse 5 and, via a focusing element, focuses it outside the housing to treat diseases. The affected tissue or organ is generally located in or near the focal point which is located in or near position 6. At position 17 a water cushion or any other kind of exit window for the acoustical energy is located.

FIG. 6 is a simplified depiction of a pressure pulse/shock wave generator, such as a shock wave head, with plane wave characteristics. Numeral 1 indicates the position of a pressure pulse generator according to the present invention (i.e., propagating energy wave source 1), which generates pressure pulses 5 which is leaving the housing at the position 17, which may be a water cushion or any other kind of exit window. Somewhat even, also referred to herein as “disturbed,” wave characteristics can be generated, in case a paraboloid is used as a reflecting element, with a point source (e.g. electrode) that is located in the focal point of the paraboloid. The pressure pulses 5 will be transmitted into the patient's body via a coupling media such as, e.g., ultrasound gel or oil and their amplitudes will be attenuated with increasing distance from the exit window 17.

FIG. 7 is a simplified depiction of a pressure pulse shock wave generator (i.e., a shock wave head of a propagating energy wave source) with divergent wave characteristics. The divergent wave fronts may be leaving the exit window 17 at point 11 where the amplitude of the wave front is high. This point 17 could be regarded as the source point for pressure pulses 5. The pressure pulse source may be a point source, that is, pressure pulse 5 may be generated by an electrical discharge of an electrode under water between electrode tips. However, pressure pulse 5 may also be generated, for example, by an explosion, referred to as a ballistic pressure pulse. The divergent characteristics of the wave front may be a consequence of the mechanical setup.

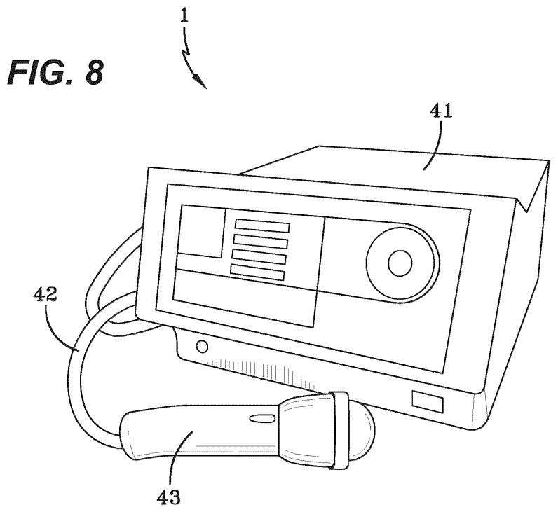

With reference to FIG. 8, an exemplary an acoustic shock wave apparatus 1 (i.e., a propagating energy wave source) is illustrated. The shock wave apparatus has a generator 41 connected by a flexible hose 42 with fluid conduits extending from the shock wave generator 41 to an applicator 43 which transmits the acoustic waves when coupled to the skin by using a fluid or acoustic gel. The applicator 43 as illustrated has a body that enables a technician to hold the applicator 43 and as illustrated this applicator is an electrohydraulic device that is filled with fluid to facilitate the transmission of the shock waves. The fluid may expand a flexible membrane in such a fashion that the membrane extends outwardly in a balloon shape fashion. As shown, this type of applicator 43 has a hydraulic spark generator using either focused or unfocused shock waves, preferably in a low energy level, less than the range of 0.01 mJ/mm² to 0.5 mJ/mm². In some embodiments, focused or unfocused shock waves may have an energy level up to at least 100.0 mJ/mm². The flexible hose 42 is connected to a fluid supply that fills the applicator 43 and expands the flexible membrane when filled. Alternatively, a ballistic, piezoelectric, or spherical acoustic shock wave device can be used to generate the desired waves.

Many different embodiments have been disclosed herein, in connection with the above description and the drawings. It will be understood that it would be unduly repetitious and obfuscating to describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a sub-combination or variation of a sub-combination.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A biome treatment system, comprising:
a propagating wave energy module operable to provide propagating wave energy treatment to a biome region of a body of a patient, wherein the propagating energy wave module being enabled to provide said propagating wave energy treatment includes being operable to deliver propagating wave energy to the biome region for causing the biome region to transition from exhibiting a baseline biome biological profile to a modified biome biological profile; and
an energy delivery management module operably coupled to the propagating energy wave module, wherein the energy delivery management module is operable to create a mapping of delivery of propagating wave energy relative to locations from where said propagating wave energy has been delivered to the biome region and to identify at least one location of the biome region that requires delivery of said propagating wave energy as a function of said mapping.
